(19) United States
(12) Patent Application Publication
(10) Pub. No.: US 2026/0034895 A1
(43) Pub. Date: Feb. 5, 2026

(54) METHOD FOR OPERATING A DRIVE OF A TRAILER, AND A TRAILER FOR A VEHICLE COMBINATION

(71) Applicant: ZF CV Systems Global GmbH, Bern (CH)

(72) Inventors: Jan Leon Kaminski, Hannover (DE); Tino Sonntag, Steyerberg (DE); Fabian Ickerott, Muenster Albachten (DE); Michael Schomburg, Barsinghausen (DE)

(21) Appl. No.: 19/357,806

(22) Filed: Oct. 14, 2025

Related U.S. Application Data
(63) Continuation of application No. PCT/EP2024/056997, filed on Mar. 15, 2024.

(30) Foreign Application Priority Data
Apr. 14, 2023 (DE) 10 2023 109 504.8

(51) Int. Cl. B60L 15/20; B62D 59/04

(52) U.S. Cl. CPC B60L 15/20; B62D 59/04; B60L 2200/28; B60L 2240/12; B60L 2240/423

(57) ABSTRACT

A method is for operating a drive of a trailer, in which a drive assembly of the trailer is actuated by a drive signal, the drive signal being used for adjusting a drive torque of the drive assembly in order to avoid destabilization of a vehicle combination including the trailer and the drive torque being adjusted as a function of a speed of the trailer or of the vehicle combination.

### CROSS-REFERENCE TO RELATED APPLICATIONS

This application is a continuation application of international patent application PCT/EP2024/056997, filed Mar. 15, 2024, designating the United States and claiming priority from German application 10 2023 109 504.8, filed Apr. 14, 2023, and the entire content of both applications is incorporated herein by reference.

### TECHNICAL FIELD

The disclosure relates to a method for operating a drive of a trailer, in which a drive assembly of the trailer is actuated by a drive signal, the drive signal being used for adjusting a drive torque of the drive assembly for stabilizing a vehicle combination including the trailer, and to a trailer for a vehicle combination. The vehicle combination is preferably a wheeled vehicle combination and includes a passenger car or a truck as a towing vehicle.

### BACKGROUND

Known trailers provided with a drive assembly, which are used with a towing vehicle in vehicle combinations, have an electric motor as the drive assembly. In order to be able to operate the electrically driven trailer reliably on public roads, it is necessary to ensure that unstable driving states of the entire vehicle combination due to the drive system do not occur. Driving situations with a large articulation angle between the towing vehicle and the trailer are particularly critical here. In such situations, the entire vehicle combination can be destabilized by way of the towing vehicle being unintentionally pushed forward by the trailer or by way of the vehicle combination folding in on itself. This folding-in like a pocket knife is known by the term jackknifing.

EP 3 845 441 A1 discloses a method for operating a drive device of a trailer, a drive signal being adapted as a function of a curvature of a bend. An applied torque of the trailer is regulated as a function of the current bend radius. The bend radius is ascertained from the wheel speeds of individual wheels of the trailer and a maximum torque that can be output is determined.

### SUMMARY

It is an object of the disclosure is to overcome the disadvantages of the prior art and to specify a method which allows safe driving of a vehicle combination in many traffic situations.

The object is achieved by various embodiments of the disclosure. An embodiment specifies a method for operating a drive of a trailer, in which a drive assembly of the trailer is actuated by a drive signal, the drive signal being used for adjusting a drive torque of the drive assembly for stabilizing a vehicle combination including the trailer, the drive torque being adjusted as a function of a speed of the trailer or of the vehicle combination.

The object is also achieved by a trailer for a vehicle combination, including a drive assembly and a controller for controlling the drive assembly, in which the controller is configured to carry out the method according to at least one of the features described in this property right application.

In a proposed method, speed information, which is preferably derived from the independently driven trailer, is the leading influencing variable on the drive torque determining the driving of the trailer. This circumstance is based on the finding that tight bends can be navigated only at low speeds, preferably at walking speed.

Relatively small bend radii, at which a larger articulation angle is formed between the towing vehicle and the trailer, are navigated relatively slowly, whereas larger bend radii can be navigated at a relatively high speed since only a relatively small articulation angle is expected, with the vehicle combination increasingly extending as the speed increases.

An articulation angle is to be understood to mean a deviation of the trailer from a longitudinal direction predefined by the towing vehicle. Large articulation angles between the towing vehicle and the trailer occur, for example, in turning situations in towns, on roundabouts or on bends on winding roads.

The method has the advantage of high system reliability. It is possible to dispense with the use of separate sensors for determining the articulation angle between the towing vehicle and trailers, this reducing costs, maintenance and servicing. The method can be applied independently of the type of trailer, such as center-axle trailer or semitrailer.

In an embodiment, the permitted value of the drive torque of the drive assembly is reduced if the speed of the trailer or of the vehicle combination undershoots a speed threshold value. It is easily possible to distinguish between safety-critical and non-safety-critical driving states using the speed threshold value. A decision is made as to whether or not the trailer may be driven. The speed threshold value is set in such a way that, above the speed threshold value, navigation of tight bends with large articulation angles between the towing vehicle and the trailer is unlikely in the context of driving physics.

In a further embodiment, a torque of an electric motor used as a drive assembly, as the drive torque of an electrically driven trailer, is adjusted as a function of the speed of the trailer or of the vehicle combination. The torque indicates the force which is applied to the drive shaft of the electric motor. The torque of the electric motor is restricted to 0 Nm below the speed threshold value, which means that the trailer is no longer driven. It is also possible to operate electrified trailers which have no fifth wheel coupling or no kingpin between the towing vehicle and the trailer, in particular center-axle trailers, via this method.

In a further embodiment, the permitted torque increases depending on the speed of the trailer or of the vehicle combination above the speed threshold value. It is assumed here that the vehicle combination has only a small articulation angle at relatively high speeds. The higher the speed, the more the vehicle combination can extend since it is assumed that it is traveling approximately straight ahead.

In a further embodiment, the speed of the trailer or of the vehicle combination is derived from redundant speed signals of the towing vehicle and/or from further speed information relating to the trailer. The redundancy from two signals ensures that the speed on which the torque regulation is based is particularly reliable. The redundant speed signals can be ascertained in particular from one or more wheel speeds and a motor speed of the trailer. The torque regulation of the electric motor of the trailer is refined and the traffic safety of the vehicle combination is improved by increasing the accuracy of the speed determination operation.

The aspects described here with reference to the method apply equally to the disclosed trailer, which has a controller for carrying out the method. This can be done by making suitable write and read accesses to a memory assigned to the trailer. The method is implemented in particular within the trailer using hardware or software or else a combination of hardware and software. The hardware of the controller includes, in particular, digital signal processors, application-specific integrated circuits, field programmable gate arrays and further suitable switching and computing components.

### BRIEF DESCRIPTION OF DRAWINGS

The invention will now be described with reference to the drawings wherein:

FIG. 1 shows a diagrammatic illustration of a vehicle combination including the trailer according to the disclosure;

FIG. 2 shows an illustration for defining an articulation angle of a vehicle combination; and,

FIG. 3 shows an embodiment for the dependence according to the disclosure of the speed of the trailer on a torque for driving the trailer.

### DETAILED DESCRIPTION

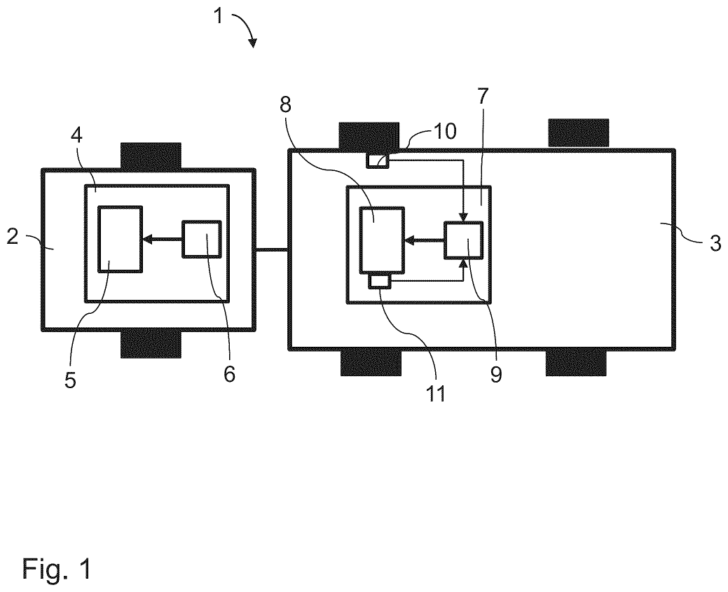

FIG. 1 shows a diagrammatic illustration of a vehicle combination with the trailer according to the disclosure. The vehicle combination 1 includes a driven towing vehicle 2 and an electrically driven trailer 3. The separately driven trailer 3 is used to increase the range of the motor-driven vehicle combination 1.

For the respective electric driving, the towing vehicle 2 includes a first drive system 4, including a motor 5 and a first controller 6. The trailer 3 likewise has a drive system 7, which has an electric motor 8 and a second controller 9. The second controller 9 is connected to a wheel speed sensor 10 and a motor speed sensor 11. The second controller 9 ascertains a speed of the trailer 3 from the signals of the wheel speed sensor 10. A redundant speed of the trailer 3 is determined from the signals of the motor speed sensor 11.

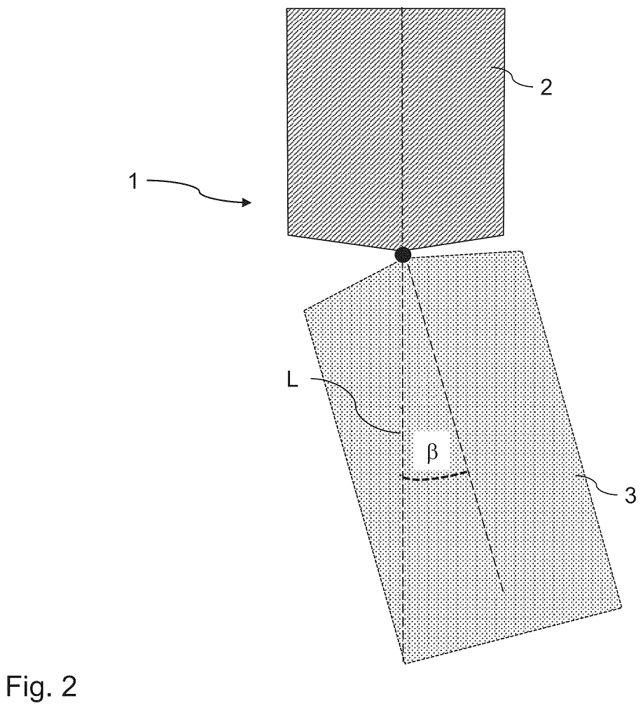

Depending on the ascertained speed of the trailer 3, the second controller determines a value of the torque M for driving the electric motor 8 of the trailer 3. In this case, an articulation angle between the towing vehicle 2 and the trailer 3 is inferred from the speed of the trailer 3. The articulation angle β is shown in more detail in FIG. 2. When the vehicle combination 1 is traveling straight ahead, the towing vehicle 2 and the trailer 3 are aligned along a common longitudinal direction L. If the vehicle combination 1 is navigating a bend, the trailer 3 deviates from this longitudinal direction L by the articulation angle β. The greater this articulation angle β, the greater the risk of a critical traffic situation. In order to prevent such a situation, the second controller 9 regulates the torque M as a function of the speed of the trailer 3.

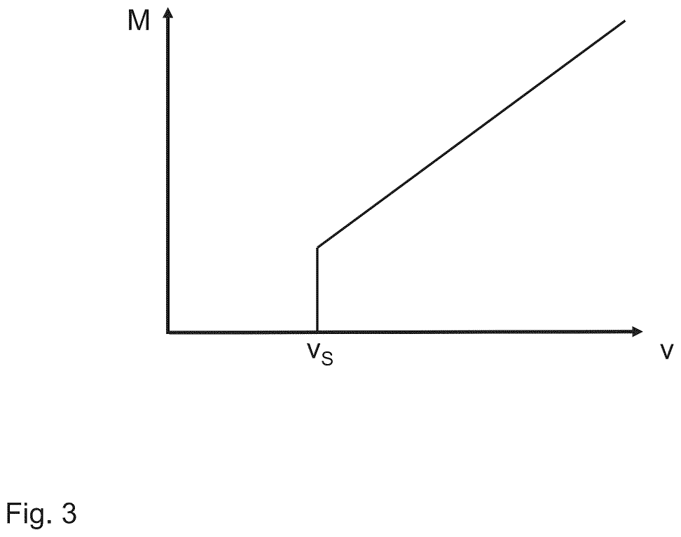

An embodiment for the dependence of the torque M of the electric motor 8 driving the trailer 3 on the speed of the trailer, which is adjusted by the second controller 9, is shown in FIG. 3. On the basis of the speed of the trailer 3, a decision is made as to whether or not the trailer 3 may be driven. A speed threshold value vₛ, which is 30 km/h for example, is defined for this purpose. If, when the currently ascertained speed v of the trailer 3 is compared with the speed threshold value vₛ, it is established that the speed threshold value vₛ is undershot, the second controller 9 does not output the torque M of the electric motor 8. That is, the trailer 3 is not driven. When the speed threshold value vₛ is exceeded by the currently measured speed v of the trailer 3, the torque M is increased depending on the speed v. Here, this increase in the torque M can take place linearly, but also in accordance with a non-linear function with respect to the speed v.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle combination
2 Towing vehicle
3 Trailer
4 Drive system of the towing vehicle
5 Motor
6 Controller
7 Drive system of the trailer
8 Electric motor
9 Controller
10 Wheel speed sensor
11 Motor speed sensor
v Speed of the trailer
vₛ Speed threshold value
M Torque
β Articulation angle
L Longitudinal direction

1. A method for operating a drive of a trailer, the method comprising:
actuating a drive assembly of the trailer via a drive signal; and,
adjusting a drive torque of the drive assembly in order to avoid destabilization of a vehicle combination including the trailer, wherein the drive torque is adjusted as a function of a speed of the trailer or of the vehicle combination.

2. The method of claim 1, wherein a permitted value of the drive torque of the drive assembly is reduced if the speed of the trailer or of the vehicle combination undershoots a speed threshold value.

3. The method of claim 2, wherein the drive torque of the drive assembly is not output if the speed threshold value is undershot.

4. The method of claim 1, wherein the trailer is an electrically driven trailer; and, a torque of an electric motor used as the drive assembly, as the drive torque of the electrically driven trailer, is adjusted as the function of the speed of the trailer or of the vehicle combination.

5. The method of claim 4, wherein the torque of the electric motor is restricted to 0 Nm below a speed threshold value.

6. The method of claim 4, wherein a permitted value of the torque increases as the function of the speed of the trailer or of the vehicle combination above a speed threshold value.

7. The method of claim 2, wherein the trailer is an electrically driven trailer; a torque of an electric motor used as the drive assembly, as the drive torque of the electrically driven trailer, is adjusted as the function of the speed of the trailer or of the vehicle combination; and, a permitted value of the torque increases as the function of the speed of the trailer or of the vehicle combination above the speed threshold value.

8. The method of claim 4, wherein a maximum permissible torque of the electric motor is ascertained as the function of the speed of the trailer or of the vehicle combination.

9. The method of claim 4, wherein the speed of the trailer or of the vehicle combination is derived from redundant speed signals of the trailer.

10. The method of claim 4, wherein the speed of the trailer or of the vehicle combination is derived from redundant speed signals of at least one of the trailer and a towing vehicle.

11. A trailer for a vehicle combination, the trailer comprising:
a drive assembly;
a controller for controlling the drive assembly;
said controller being configured to:
actuate the drive assembly of the trailer via a drive signal; and,
adjust a drive torque of the drive assembly in order to avoid destabilization of the vehicle combination including the trailer, wherein the drive torque is adjusted as a function of a speed of the trailer or of the vehicle combination.
